(19) United States
(12) Patent Application Publication
(10) Pub. No.: US 2020/0203895 A1
(43) Pub. Date: Jun. 25, 2020

(54) ADAPTER ASSEMBLY FOR CONTACTLESS TRANSFER OF ELECTRICAL POWER

(71) Applicant: Arne Veidung Innovasjon AS, Bergen (NO)

(72) Inventor: Arne Veidung, Paradis (NO)

(21) Appl. No.: 16/493,728

(22) PCT Filed: Mar. 12, 2018
(86) PCT No.: PCT/NO2018/050072

§ 371 Date: Sep. 12, 2019

(30) Foreign Application Priority Data
Mar. 13, 2017 (NO) 20170364

(51) Int. Cl. H01R 13/66; H01F 38/14; H01F 7/02; H01R 24/68; H01R 24/76; H02J 50/10

(52) U.S. Cl. CPC H01R 13/6633; H01F 38/14; H01F 7/02; H01R 2103/00; H01R 24/76; H02J 50/10; H01R 24/68

(57) ABSTRACT

Adapter assembly for contactless transfer of electrical power, comprising a receptacle adapter (110) and a plug adapter (120), wherein the receptacle adapter (110) and the plug adapter (120) are provided with corresponding magnetic fastening means (113,123), respectively, for mutual connection by means of a magnetic force, wherein the receptacle adapter (110) and plug adapter (120) are provided with means for contactless transfer of electrical power in that the receptacle adapter (110) comprises a primary side (131) of a transformer (132) and the plug adapter (120) comprises a secondary side (133) of the transformer (132), such that when the receptacle adapter (110) and plug adapter (120) are connected together via the magnetic fastening means(113,123), the transformer (132) is capable of transferring power from the receptacle adapter (110) to the plug adapter (120) without physical contact between power transferring parts.

### FIELD OF THE INVENTION

The present invention is related to an adapter assembly for contactless transfer of electrical power, comprising a receptacle adapter and a plug adapter, wherein the receptacle adapter and the plug adapter are provided with corresponding magnetic fastening means, respectively, for mutual connection by means of a magnetic force, wherein the receptacle adapter and plug adapter are provided with means for contactless transfer of electrical power in that the receptacle adapter comprises a primary side of a transformer and the plug adapter comprises a secondary side of the transformer, such that when the receptacle adapter and plug adapter are connected together via the magnetic fastening means, the transformer is capable of transferring power from the receptacle adapter to the plug adapter without physical contact between power transferring parts.

The present invention is especially related to an adapter assembly for contactless transfer of electrical power between an AC power supply and a consumer, such as an electric device, providing a simpler and safer use of electric equipment.

### BACKGROUND

There is known a variety of different electrical receptacles, also known as electrical outlets, being used around the world. In e.g. https://www.skyscanner.no/nyheter/alt-du-trenger-vite-om-internasjonale-stikkontakter-og-reiseadaptere many of the most used solutions are described.

In U.S. Pat. No. 3,363,214 is disclosed a magnetic plug adapter having plugs at one end to be received in conventional baseboard sockets provided with socket terminals on the other end which taper to receive, a second adapter having tapered contacts on one end and sockets on the other end to receive the prongs of a conventional plug. A magnet is disposed in each of the mating faces of the two adapters to and the holding strength thereof is such as to permit separation between the adapters rather than between the first named adapter and receptacles.

From WO2014088215 A1 it is known a plug-type outlet cover set, and method for setting same, wherein a plug adapter and an outlet cover are used so that the outlet cover is inserted into a power outlet and a power plug is inserted into the plug adapter, magnets are built into the plug adapter and the outlet cover so that the plug adapter and the outlet cover are attached by using the magnetic force therein in order for electricity to be used, and the power is cut by the magnet in the outlet cover when the outlet cover set is removed so that accidents such as an electric shock can be prevented.

In U.S. Pat. No. 9,083,110 it is described a quick disconnect power adapter for maintaining a connection between a plug and a receptacle. In various embodiments, the quick disconnect power adapter maintains a completed circuit for providing power from a power source to an electrical device with a releasable fastener. In particular embodiments, the releasable fastener includes one or more magnets. In various embodiments, the quick disconnect power adapter is configured such that the electrical contact points of the plug and receptacle cannot be touched or otherwise contacted by a user when the plug and receptacle are not engaged.

The main disadvantage of the prior art solutions is that they require a physical contact between electrically conducting parts/elements. In U.S. Pat. No. 3,363,214 and U.S. Pat. No. 9,083,110 there are arranged conductors in the plug adapter, while in WO2014088215 a core magnet in the plug adapter is used for physically connecting the electrically conducting parts/elements.

US 2013/0303024 A1 discloses a safety electrical interconnect that mitigates shock risk, it adapts into standard electrical sockets, outlets or electrical wiring; it conceals electrically energized contacts yet is capable of transferring electrical energy between at least two parts inductively. A first part of the invention is capable of being plugged directly into a standard electrical socket or outlet using a plurality of prongs or pins protruding from at least a first surface. This first part is capable of passing electrical energy wirelessly using inductive transformer action when connected to one or more second parts of the invention. These second parts of the invention have one or more female connections capable of receiving prongs or pins from an electrical appliance or machine plug.

JP H10208804 A discloses a device comprising a sealed/waterproof receptacle with a built-in induction coil to which electric power is applied, and an adapter which is equipped with an induction coil that is placed in a magnetic field made by the induction coil when it is mounted on the receptacle while is equipped with a power supply regulating part which turns an output of the induction coil into an output corresponding with specifications of a load and with a receptacle part for load connection. The adapter is attachable/detachable relative to the receptacle. Because the receptacle part for load connection is provided to the adapter which carries out non-contact power transmission to and from the receptacle by means of electromagnetic induction, the receptacle itself can have a completely waterproof structure through it can be connected with an ordinary load.

US 2003/186593 A1 disclose an electric plug provided with at least one track adapted for receiving a clip for easy handling of the plug in connection with arrangement from a receptacle.

A further disadvantage of the prior art solutions is that they provide no suitable fixed arrangement of the receptacle adapter to the electrical receptacle.

It is further a disadvantage of the prior art solutions that they are not arranged for suitable transformation of transferred electrical power.

A disadvantage of prior art is further that they make use of movable parts which are exposed to wear and accordingly constitute a risk for heat generation and fire. There is accordingly a need for an adapter assembly that removes the need for physical contact between electrically conducting parts/elements in the receptacle adapter and the plug adapter.

There is further a need for an adapter assembly that provides a safer installation of the receptacle adapter to a junction box/electrical receptacle.

It is further a need for an adapter assembly capable of transforming supplied electrical power to desired electrical power for an electrical device connected at the other side.

There is further a need for an adapter assembly without movable parts reducing the wear and risk for heat generation and fire.

### OBJECTS OF THE PRESENT INVENTION

The main object of the present invention is to provide an adapter assembly for contactless transfer of electrical power partly or entirely solving the above mentioned drawbacks of prior art.

It is further an object of the present invention to provide an adapter assembly for contactless transfer of electrical power which provides simpler and safer use of electric equipment for the user.

An object of the present invention is to provide an adapter assembly for contactless transfer of electrical power which can be retrofitted or replacing existing electrical receptacles and plugs for increasing the safety.

It is an object of the present invention to provide an adapter assembly for contactless transfer of electrical power increasing the safety and preventing children and youngster or others from getting electric shock at unconventional contact.

It is further an object of the present invention to provide an adapter assembly for contactless transfer of electrical power which can be adapted all standards of receptacles and plugs, as well as power supply grid standards.

An object of the present invention is to provide an adapter assembly for contactless transfer of electrical power which can be easily attached to or detached from existing receptacles or plugs.

It is further an object of the present invention to provide an adapter assembly for contactless transfer of electrical power which removes the need for physical contact between electrical power transferring parts.

There is further an object of the present invention to provide an adapter assembly for contactless transfer of electrical power that eliminates current leakage in wall-mounted electrical receptacle.

An object of the present invention is to provide an adapter assembly for contactless transfer of electrical power without mechanical wear due to fixed installation.

It is further an object of the present invention to provide an adapter assembly without movable parts/components reducing the risk of heat generation and fire. Further objects of the present invention will appear from consideration of the following description, claims and attached drawings.

It is also an object to provide a more secure fastening between the receptacle adapter and the plug adapter.

### SUMMARY OF THE INVENTION

An adapter assembly for contactless transfer of electrical power according to the present invention is disclosed in claim 1. Preferable features of the adapter assembly are disclosed in the remaining claims.

According to the invention an adapter assembly for contactless transfer of electrical power is provided, comprising a receptacle adapter and a plug adapter, wherein the receptacle adapter and the plug adapter are provided with corresponding magnetic fastening means, respectively, for mutual connection by means of a magnetic force, wherein the receptacle adapter and plug adapter are provided with means for contactless transfer of electrical power in that the receptacle adapter comprises a primary side of a transformer and the plug adapter comprises a secondary side of the transformer, such that when the receptacle adapter and plug adapter are connected together via the magnetic fastening means, the transformer is capable of transferring power from the receptacle adapter to the plug adapter without physical contact between power transferring parts, wherein

the receptacle adapter comprises a main body accommodating the primary side of the transformer and the magnetic fastening means, the magnetic fastening means being recessed in the main body and arranged for receiving and accommodating the magnetic fastening means of the plug adapter, and

the plug adapter comprises a main body accommodating the secondary side of the transformer and the magnetic fastening means, the magnetic fastening means protruding from the main body and adapted for arrangement to the magnet fastening means of the receptacle adapter.

The magnetic fastening means of the receptacle adapter can be placed in a circular recess on a front side of the main body.

The front side of the main body may comprise two or more circular female recesses with magnetic fastening means.

The magnetic fastening means of the plug adapter can be placed in a circular protrusion on a front side of the main body.

The front side of the main body may comprise two or more circular male protrusions with magnetic fastening means.

The receptacle adapter can be connected to an AC power supply cord.

The plug adapter can also be connected to an AC power supply cord.

The receptacle adapter can be a female connector and the plug adapter can be a male connector, for connection of two AC power supply cords.

Two or more receptacle adapters can be provided in the main body, one above the other, wherein the main body is a receptacle cover or cover box arranged for placement on a wall, and the receptacle adapters are connected to an AC power supply.

Two or more receptacle adapters and a junction box can be integrated in a receptacle cover, adapted for arrangement in connection with a cavity of a wall.

The transformer can be arranged for transforming supplied AC current/voltage at a certain frequency to a desired output AC current/voltage of a desired frequency.

The transformer may further be arranged for transforming supplied AC current/voltage to a desired DC current/voltage.

The receptacle adapter and/or the plug adapter can be provided with a rectifier unit connected at the secondary side of the transformer.

The receptacle adapter may further be provided with at least one track adapted for receiving a clip for easy handling of the receptacle adapter in connection with arrangement to and/or from a standard electrical receptacle.

The receptacle adapter can be adapted for connection to an AC power supply at one end and the plug adapter at the other end, the plug adapter being arranged for connection to a power cord at one end and to the receptacle adapter at the other end, wherein the receptacle adapter and plug adapter are provided with said magnetic fastening means, respectively.

According to the invention a receptacle adapter for contactless transfer of electrical power is provided, wherein the receptacle adapter is provided with magnetic fastening means and with means for contactless transfer of electrical power in that the receptacle adapter comprises a primary side of a transformer for transferring power from the receptacle adapter to a plug adapter without physical contact between power transferring parts, wherein the receptacle adapter comprises a main body accommodating the primary side of the transformer and the magnetic fastening means, the magnetic fastening means being recessed in the main body and arranged for receiving and accommodating magnetic fastening means of the plug adapter.

According to the invention a plug adapter for contactless transfer of electrical power is provided, wherein the plug adapter is provided with magnetic fastening means and with means for contactless transfer of electrical power in that the plug adapter comprises a secondary side of a transformer for transferring power from the plug adapter to a receptacle adapter without physical contact between power transferring parts, wherein the plug adapter comprises a main body accommodating the secondary side of the transformer and the magnetic fastening means, the magnetic fastening means protruding from the main body and adapted for arrangement to magnet fastening means f the receptacle adapter.

According to the invention an adapter assembly for contactless transfer of electrical power is provided, comprising a receptacle adapter and a plug adapter, the receptacle adapter being adapted for connection to an AC power supply at one end and the plug adapter at the other end, the plug adapter being adapted for connection to a power cord at one end and to the receptacle adapter at the other end, wherein the receptacle adapter and plug adapter are provided with corresponding magnetic fastening devices, respectively, for connecting them together by means of a magnetic force, wherein the receptacle adapter and plug adapter are provided with means for contactless transfer of electrical power by that the receptacle adapter is arranged with a primary side of a transformer and the plug adapter is arranged with a secondary side of the transformer, such that when the receptacle adapter and plug adapter are connected together via the magnetic fastening devices the transformer is capable of transferring power from the receptacle adapter to the plug adapter without physical contact between power transferring parts, wherein the receptacle adapter is formed by a main body accommodating the primary side of the transformer connected to conducting connectors projecting from one end and accommodating the magnetic fastening device at the other end, the magnetic fastening device being recessed in the main body and arranged for receiving and accommodating the magnetic fastening device of the plug adapter, and the plug adapter is formed by a main body accommodating the secondary side of the transformer connected to female conductive connectors at one end arranged for receiving and accommodating conductive connectors of a plug of a power cord or integrated in a plug of a power cord, and at the other end is provided with the magnetic fastening device, the magnetic fastening device protruding from the main body and adapted for arrangement to the magnet fastening device of the receptacle adapter.

By the present invention is achieved an adapter assembly for contactless transfer of electrical power which can be retrofitted or replace electrical receptacles and plugs presently used today over the whole world, by adapting the receptacle adapter to the standard of the power supply grid.

By the present invention is achieved an adapter assembly for contactless transfer of electrical power providing a simpler and safer way to connect an electrical device via a plug to an electrical receptacle.

The present invention also provides increased safety by that there is no physical contact between electrical conductive parts of the receptacle adapter and plug adapter. By this is achieved that kids or others will not get electrical shock at untraditional contact with the receptacle adapter.

By the present invention is provided an adapter assembly for contactless transfer of electrical power which can be arranged for transformation of AC power at a certain frequency to AC power with desired frequency, or from AC power to desired DC power. A transformation to desired DC power removes the need for transformers/converters in the power supply of an electrical device.

The present invention also provides an adapter assembly for contactless transfer of electrical power where the receptacle adapter can be fixed to the power supply, increasing the safety of the electrical receptacle.

As the present invention contains now movable parts there will be no wear and further the risk for heat generation and fire is reduced.

Further preferable features and advantageous details of the present invention will appear from the following example description, claims and attached drawings.

### DESCRIPTION OF THE DIAGRAMS

The present invention will below be described in further detail with references to the attached drawings, where:

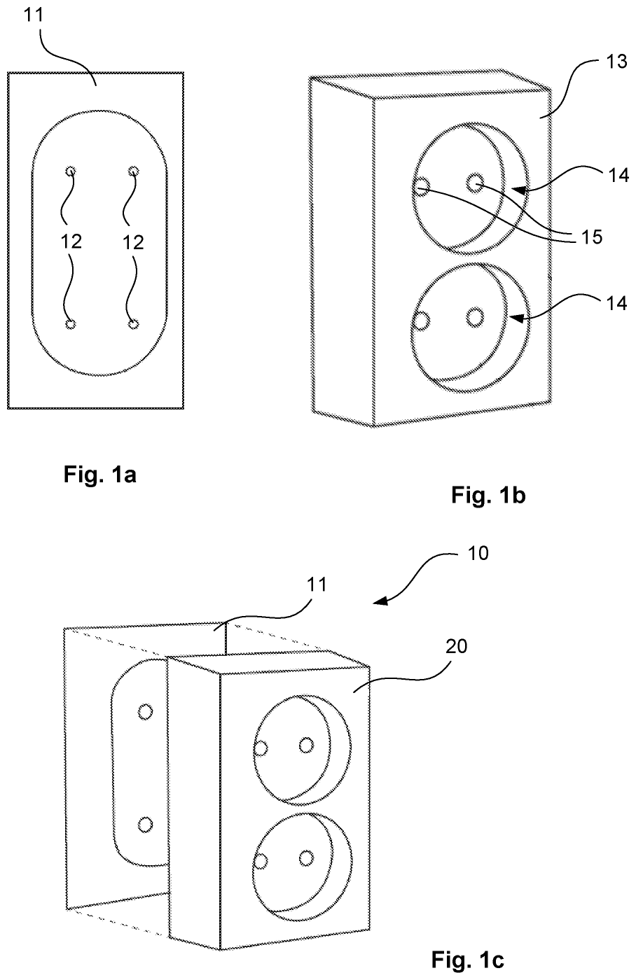

FIG. 1a-c shows principle drawings of a wall-mounted standard electrical receptacle according to prior art,

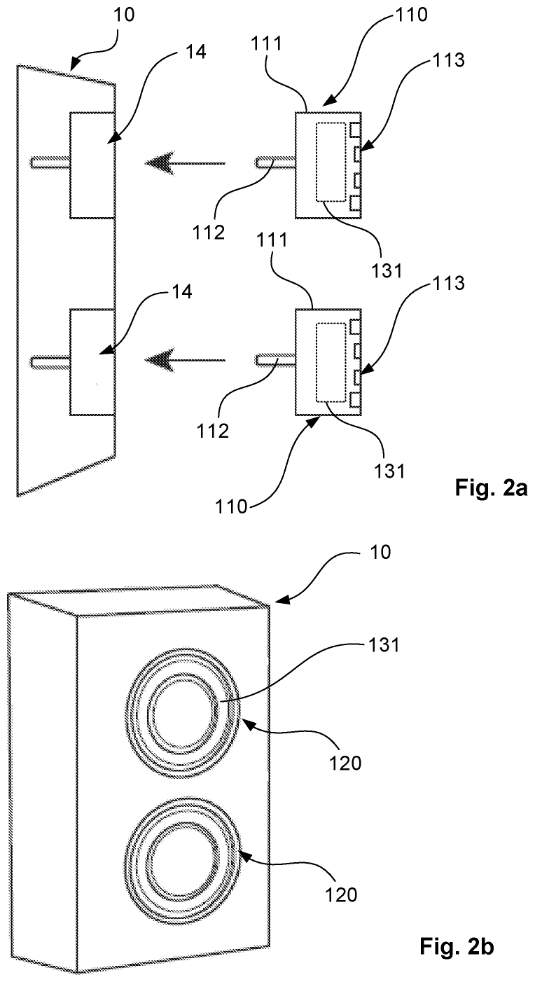

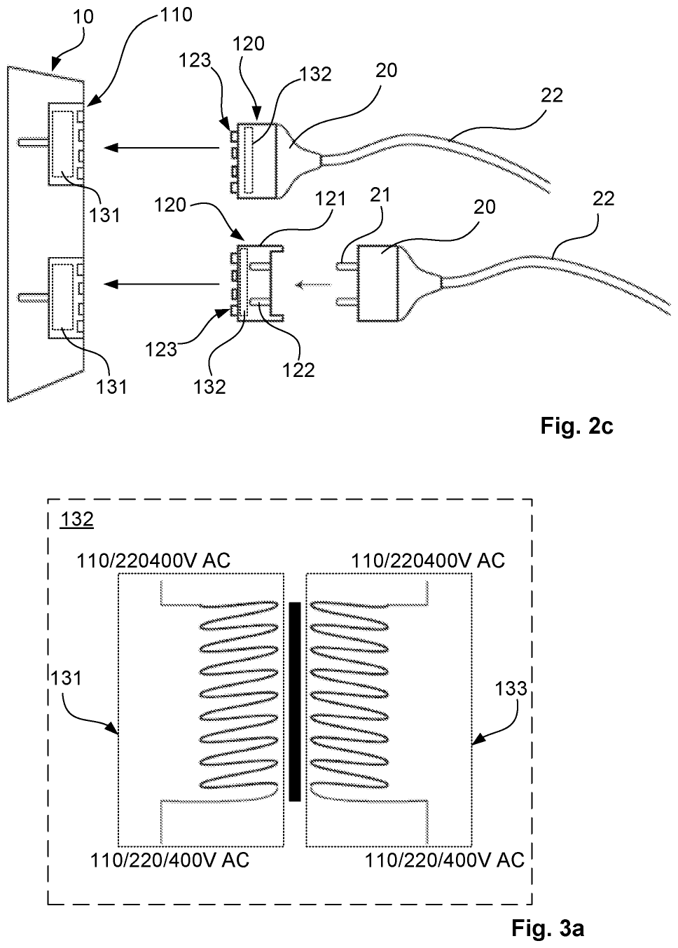

FIG. 2a-c shows principle drawings of an adapter assembly for contactless transfer of electrical power according to a first embodiment of the present invention,

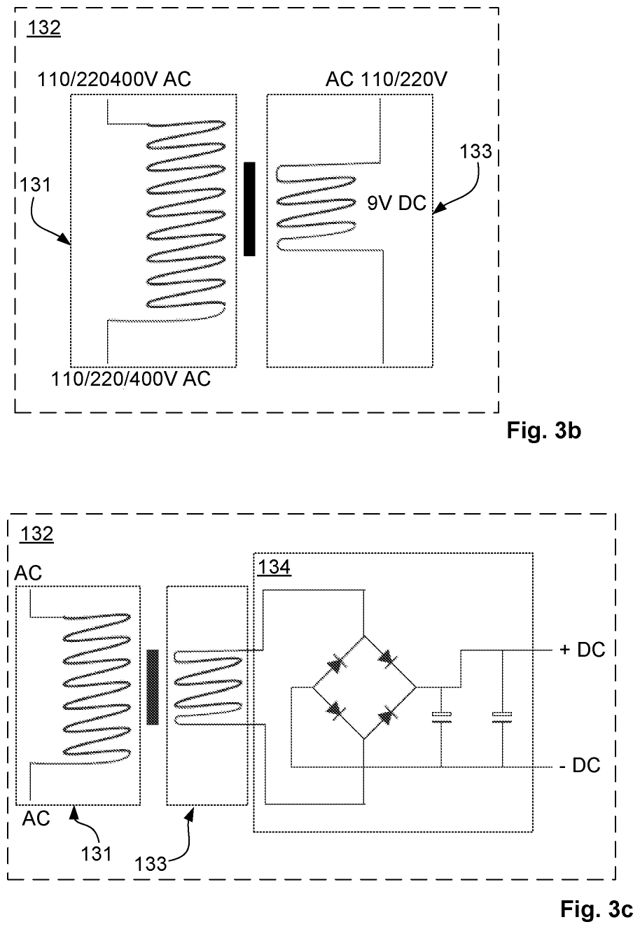

FIG. 3a-c shows principle drawings of contactless power transfer means according to the present invention,

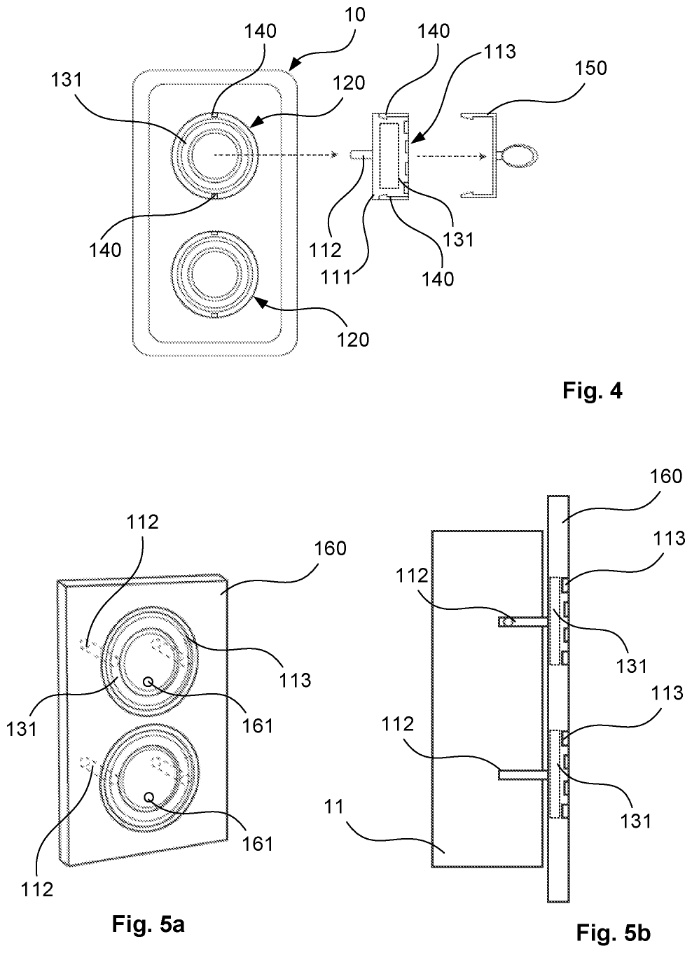

FIG. 4 is a principle drawing of a modification of the first embodiment with a principle drawing of a tool for insertion and/or removal of a receptacle adapter for the adapter assembly according to the present invention to/from a standard electrical receptacle,

FIG. 5a-b shows principle drawings of an adapter assembly for contactless transfer of electrical power according to a second embodiment of the present invention,

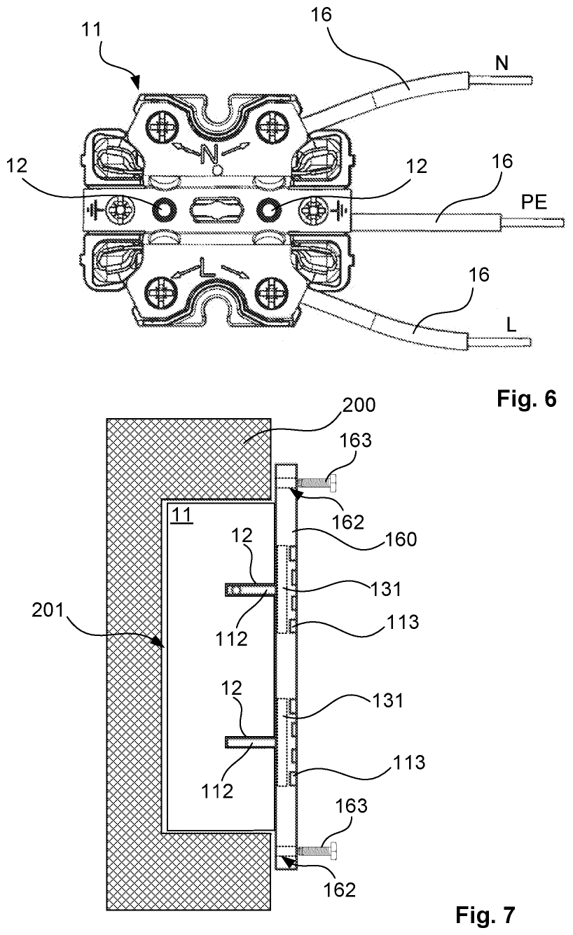

FIG. 6 is a principle drawing of a junction box according to prior art, and

FIG. 7 is a principle drawing of a further embodiment of the adapter assembly for contactless transfer of electrical power according to the present invention.

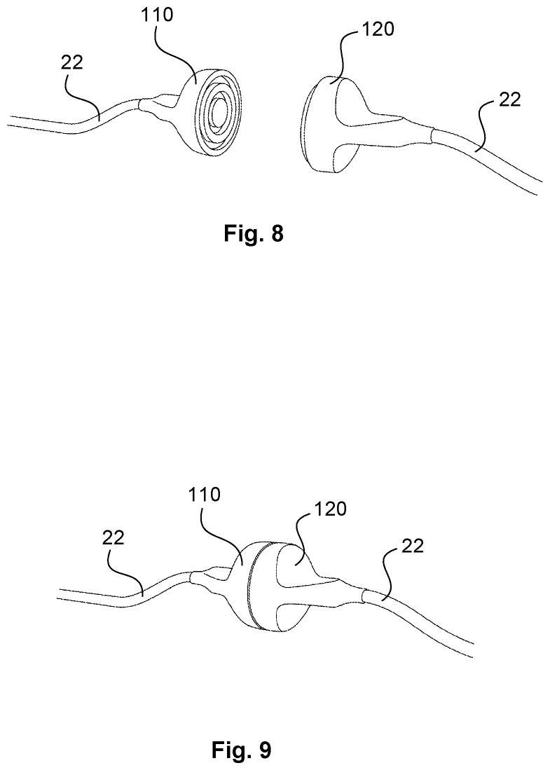

FIGS. 8 and 9 shows an adapter assembly for contactless transfer of electrical power according to a further embodiment of the present invention.

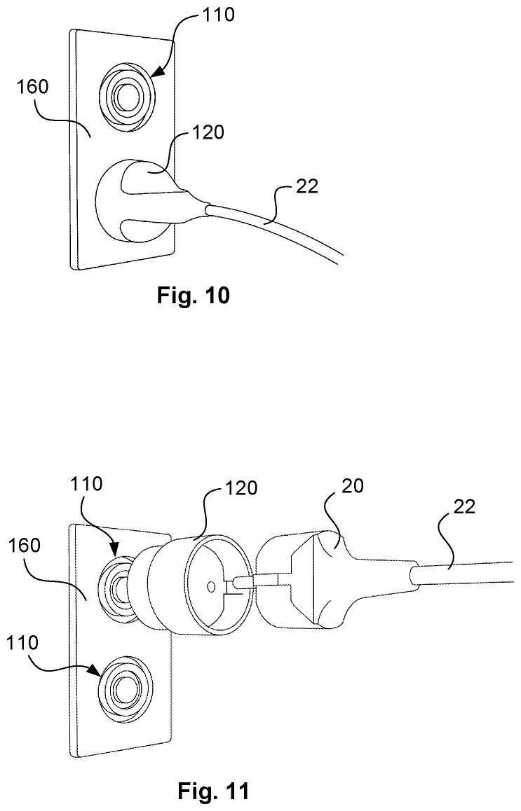

FIGS. 10 and 11 shows further embodiments of the adapter assembly for contactless transfer of electrical power according to the present invention.

Reference is now made to FIGS. 1a-c showing a wall mounted standard electrical receptacle 10 according to prior art. The electrical receptacle 10 according to prior art is formed by wall-mounted junction box 11 arranged to connect to an AC power supply grid, which exhibits terminals 12 for receiving conductive connectors 21 of a plug 20 of a power cord 22 (shown in FIG. 2c) of a consumer, typically an electrical device. The electrical receptacle 10 further comprises a receptacle cover 13 which is fixed to the junction box 11 and exhibits recesses 14 provided with holes 15 for receiving and accommodating the plug 20 and conductive connectors 21a and the arrange the plug 20 safely to the electrical receptacle 10, as well as protecting the environment from electrical conductive parts.

Reference is now made to FIGS. 2a-c showing a first embodiment of an adapter assembly for contactless transfer of electrical power according to a first embodiment of the present invention. According to the first embodiment of the adapter assembly according to the present invention the adapter assembly comprises a receptacle adapter 110 formed by a main body 111 and provided with conductive connectors 112 at one end corresponding to the type of electrical receptacle 10 and at the other end is provided with a magnetic fastening means 113. Accordingly, the receptacle adapter 110 is adapted to be received in the recesses 14 of the electrical receptacle 10 and provide a magnetic fastening means 113 for connection of a plug adapter 120 according to the present invention. The plug adapter 120 of the adapter assembly according to the first embodiment of present invention is formed by a main body 121 which at one end is provided with female conductive connectors 122 adapted for receiving the conductive connectors 21 of a plug 20 and which at the other end is provided with a magnet magnetic fastening means 123 adapted for connection to the receptacle adapter 110 by magnetic force. Accordingly, with plug adapters 120 arranged to the relevant plugs 20 of a power cord 22 any kind of power cord 22 can be connected to the electrical receptacle 10 by means of the adapter assembly according to the present invention.

The magnet fastening means 113 of the receptacle adapter 110 is preferably recessed in the main body 111, while the magnetic fastening means 123 of the plug adapter 120 is preferably protruding from the end of the main body 121, such than when the plug adapter 120 is arranged to the receptacle adapter 110, the magnetic fastening means 113 of the receptacle adapter 110 is arranged to receive and accommodate the magnetic fastening means 123 of the plug adapter 120. The magnetic retaining force of the magnetic fastening means 113, 123 is preferably lower than the retaining force between the conductive connectors 112 and terminals 12 of the junction box 11. In a preferable embodiment the magnetic fastening means 113, 123 exhibit a mainly circular shape. By this is achieved an adequate magnetic connection that will exhibit sufficient magnetic force holding the plug adapter 120 to the receptacle adapter 110.

According to the present invention the adapter assembly is further arranged for contactless transfer of electrical power between the electrical receptacle 10 and the plug adapter 120 by that the receptacle adapter 110 and plug adapter 120 are provided with magnetic or inductive means 131, 132, respectively, for contactless transfer of electrical power, which are connected with the conductive connectors 112 and female conductive connectors 122, respectively.

According to the present invention the power cord 22 can also be manufactured with a plug adapter 120 as shown in FIGS. 2c and 8.

Reference is now made to FIGS. 3a-c. Accordingly, the receptacle adapter 110 is provided with primary side 131 of a transformer 132 and the plug adapter 120 is provided with secondary side 133 of the transformer 132, such that when the receptacle adapter 110 and plug adapter 120 are connected together via the magnetic fastening means 113, 123 the transformer 132 is capable of transferring power from the receptacle adapter 110 to the plug adapter 120 without physical contact between electrical power transferring parts.

By means of the transformer 132 the adapter assembly will be capable of transforming supplied AC current/voltage (e.g. 110 V, 220 V, 400 V) at given frequency (e.g. 50-60 Hz) to desired output AC current/voltage (e.g. 110 V, 220 V, 400 V) at desired frequency (e.g. 50-60 Hz) adapted to the electrical device connected to the adapter assembly via a power cord 22.

According to a further embodiment of the adapter assembly according to the present invention, the secondary side 133 of the transformer 130, i.e. the plug adapter 120 is further provided with a rectifier unit 134 capable of rectifying supplied AC current/voltage (e.g. 110 V, 220 V, 400 V) to desired DC current/voltage, such as e.g. 3, 5, 9, 12, 24 etc. Accordingly, the plug adapter 120 then removes the need for transformer and/or rectifier in the power cord 22 or electrical device.

The primary 131 and secondary 133 side of the transformer can be separated by air, iron-dust or iron. By use of iron dust or iron between the two sides 131, 133 this can be arranged in either one of the receptacle adapter 110 or plug adapter 120, or in both.

Accordingly, the plug adapter 120 can be arranged to the plug 20 of a power cord 22 until a supplier replaces the standard plug 20 with a plug with the integrated plug adapter 120 according to the present invention arranged for AC or DC according to the requirements of the electrical device.

Reference is now made to FIG. 4 showing a modified embodiment of receptacle adapter 110 as described above. According to a modified embodiment of the receptacle adapter 110 according to the present invention the main body 111 is provided with at least one track 140, preferably two diametrically opposite tracks 140, adapted for receiving a clip 150 designed to enter the tracks 140, By means of barbs on the clip 150 and corresponding recesses in the tracks 140 the clip 150 can engage the receptacle adapter 110 and the receptacle adapter 110 can in an easy manner be pulled out of engagement with or insertion into the electric receptacle 10.

Reference is now made to FIGS. 5a-b showing principle drawings of a second embodiment of a receptacle adapter 110 of the adapter assembly according to the present invention. In the second embodiment the receptacle adapter(s) 110 is/are integrated in a receptacle cover 160 which is adapted to replace the standard receptacle cover 20. In this embodiment the receptacle cover 160 is preassembled with the receptacle adapter(s) 110, such that the receptacle adapter(s) 110 are fixed therein, e.g. by that they are casted in place or fixed by appropriate fastening means. By this embodiment the standard receptacle cover 20 can be removed from the junction box 11 and the receptacle cover 160 with the integrated receptacle adapter(s) 110 can be connected to the junction box 11 by insertion of the conductive connectors 112 in the terminals 12 of the junction box 11 and fixation of the receptacle cover 160 to the junction box 11 by means of standard screw connections 161.

Reference is now made to FIG. 6 which is an example of a standard junction box 11 regardless of supplier with conductive connectors 16 for connection to respective conductors of an AC power supply grid and terminals 12 for connection thereto. The mentioned conductive connectors 16 can be omitted and the conductors of the AC power supply grid can be connected directly to the junction box 11. Reference is also made to FIG. 7 showing a principle drawing of a further embodiment of the adapter assembly according to the present invention where the above described receptacle cover 160 in addition to the receptacle adapter(s) 110 also has a junction box 11 integrated, prearranged to the receptacle cover 160 and receptacle adapter(s) 110. In such an embodiment the receptacle cover 160 is preferably provided with through holes 162 for accommodating fastening means 163, such as screws, enabling the receptacle cover 160 with the integrated junction box 11 and receptacle adapter(s) 110 to be fixed to a wall 200. By this embodiment the receptacle cover 160 according to the present invention will replace the need for a junction box 11 as used in the above described embodiments. By this embodiment is achieved a solution where the conductors of the AC power supply grid can be connected directly to the integrated junction box 11 or connected to conductive connectors 16 arranged thereto, and the junction box 11 can be received in a cavity 201 of a wall 200 and the receptacle cover 160 fixed to the wall 200 outside the cavity 201 as shown in FIG. 7 or that the receptacle cover 160 is arranged for being fixed to a wall 200 surface for exterior arrangement.

According to a further embodiment of the present invention at least one safety device (not shown), in the form of e.g. a fuse, is arranged in either the receptacle adapter 110 or plug adapter 120, or in both.

Reference is now made to FIGS. 8-9 showing principle drawings of a further embodiment of the adapter assembly according to the present invention. FIG. 8 shows a female plug adapter 110 connected to a power cord 22, and a male receptacle adapter 120 connected to a power cord 22. When the female plug adapter 110 is magnetically connected to the male receptacle adapter 120, an extension cord is provided. The magnet fastening means 113 of the receptacle adapter 110 is as previously disclosed recessed in the main body 111, while the magnetic fastening means 123 of the plug adapter 120 is protruding from the end of the main body 121, such than when the plug adapter 120 is arranged to the receptacle adapter 110, the magnetic fastening means 113 of the receptacle adapter 110 is arranged to receive and accommodate the magnetic fastening means 123 of the plug adapter 120. In a preferable embodiment the magnetic fastening means 113, 123 exhibit a mainly circular shape. By this is achieved an adequate magnetic connection that will exhibit sufficient magnetic force holding the plug adapter 120 to the receptacle adapter 110.

According to the present invention the adapter assembly is arranged for contactless transfer of electrical power between the electrical receptacle 110 and the plug adapter 120 by that the receptacle adapter 110 and plug adapter 120 are provided with magnetic or inductive means 131, 132, respectively, for contactless transfer of electrical power, which are connected with respective power cords 22.

The receptacle adapter 110 is, as shown in FIGS. 3a-c, provided with primary side 131 of a transformer 132 and the plug adapter 120 is provided with secondary side 133 of the transformer 132, such that when the receptacle adapter 110 and plug adapter 120 are connected together via the magnetic fastening means 113, 123 the transformer 132 is capable of transferring power from the receptacle adapter 110 to the plug adapter 120 without physical contact between electrical power transferring parts.

Reference is now made to FIGS. 10-11 showing principle drawings of a further embodiment of the adapter assembly according to the present invention. In the shown embodiment the receptacle adapters 110 are integrated in a receptacle cover 160 as a junction box, which is mounted on or in a wall in the same manner as a typical electrical receptacle. In this embodiment the receptacle cover box 160 is preassembled with the receptacle adapters 110, such that the receptacle adapters 110 are fixed therein, e.g. by that they are casted in place or fixed by appropriate fastening means.

In FIG. 10 a plug adapter 120 connected to a power cord 22 is magnetically connected to a lower receptacle adapter 110 integrated in the receptacle cover box 160. In FIG. 11 a standard plug 20 connected to a power cord 22 is inserted in the receptacle adapter 120, as previously disclosed, and the receptacle adapter 120 is magnetically connected to an upper receptacle adapter 110 integrated in the receptacle cover 160 or box.

1. Adapter assembly for contactless transfer of electrical power, comprising a receptacle adapter (110) and a plug adapter (120), wherein the receptacle adapter (110) and the plug adapter (120) are provided with corresponding magnetic fastening means (113,123), respectively, for mutual connection by means of a magnetic force, wherein the receptacle adapter (110) and plug adapter (120) are provided with means for contactless transfer of electrical power in that the receptacle adapter (110) comprises a primary side (131) of a transformer (132) and the plug adapter (120) comprises a secondary side (133) of the transformer (132), such that when the receptacle adapter (110) and plug adapter (120) are connected together via the magnetic fastening means (113,123), the transformer (132) is capable of transferring power from the receptacle adapter (110) to the plug adapter (120) without physical contact between power transferring parts,
characterized in that
the receptacle adapter (110) comprises a main body (111) accommodating the primary side (131) of the transformer (132) and the magnetic fastening means (113), the magnetic fastening means (113) being recessed in the main body (111) and arranged for receiving and accommodating the magnetic fastening means (123) of the plug adapter (120), and
the plug adapter (120) comprises a main body (121) accommodating the secondary side (133) of the transformer (132) and the magnetic fastening means (123), the magnetic fastening means (123) protruding from the main body (121) and adapted for arrangement to the magnet fastening means (113) of the receptacle adapter (110).

2. Adapter assembly according to claim 1, characterized in that the magnetic fastening means (113) of the receptacle adapter (110) is placed in a circular recess on a front side of the main body (111).

3. Adapter assembly according to claim 2, characterized in that front side of the main body (111) comprises two or more circular female recesses with magnetic fastening means (113).

4. Adapter assembly according to claim 1, characterized in that magnetic fastening means (123) of the plug adapter (120) is placed in a circular protrusion on a front side of the main body (121).

5. Adapter assembly according to claim 4, characterized in that front side of the main body (121) comprises two or more circular male protrusions with magnetic fastening means (123).

6. Adapter assembly according to claim 1, characterized in that the receptacle adapter (110) is connected to an AC power supply cord (22).

7. Adapter assembly according to claim 1, characterized in that the plug adapter (120) is connected to an AC power supply cord (22).

8. Adapter assembly according to claims 6 and 7, characterized in that the receptacle adapter (110) is a female connector and the plug adapter (120) is a male connector, for connection of two AC power supply cords (22).

9. Adapter assembly according to claim 1, characterized in that two or more receptacle adapters (110) are provided in the main body, one above the other, wherein the main body is a receptacle cover or cover box (160) arranged for placement on a wall, and the receptacle adapters (110) are connected to an AC power supply.

10. Adapter assembly to according to claim 1, characterized in that two or more receptacle adapters (110) and a junction box (11) are integrated in a receptacle cover (160) adapted for arrangement in connection with a cavity (201) of a wall (200).

11. Adapter assembly according to claim 1, characterized in that the transformer (132) is arranged for transforming supplied AC current/voltage at a certain frequency to a desired output AC current/voltage of a desired frequency.

12. Adapter assembly according to claim 1, characterized in that the transformer (132) is arranged for transforming supplied AC current/voltage to a desired DC current/voltage.

13. Adapter assembly according to claim 12, characterized in that the receptacle adapter (110) and/or the plug adapter (120) is provided with a rectifier unit (134) connected at the secondary side (133) of the transformer (132).

14. Adapter assembly according to claim 1, characterized in that the receptacle adapter (110) is provided with at least one track (140) adapted for receiving a clip (150) for easy handling of the receptacle adapter (110) in connection with arrangement to and/or from a standard electrical receptacle (10).

15. Adapter assembly according to claim 1, characterized in that the receptacle adapter (110) is adapted for connection to an AC power supply at one end and the plug adapter (120) at the other end, the plug adapter (120) being adapted for connection to a power cord (22) at one end and to the receptacle adapter (110) at the other end, wherein the receptacle adapter (110) and plug adapter (120) are provided with said magnetic fastening means (113, 123), respectively.

16. Receptacle adapter (110) for contactless transfer of electrical power, wherein the receptacle adapter (110) is provided with magnetic fastening means (113) and with means for contactless transfer of electrical power in that the receptacle adapter (110) comprises a primary side (131) of a transformer (132) for transferring power from the receptacle adapter (110) to a plug adapter (120) without physical contact between power transferring parts, characterized in that
the receptacle adapter (110) comprises a main body (111) accommodating the primary side (131) of the transformer (132) and the magnetic fastening means (113), the magnetic fastening means (113) being recessed in the main body (111) and arranged for receiving and accommodating magnetic fastening means (123) of the plug adapter (120).

17. Plug adapter (120) for contactless transfer of electrical power, wherein the plug adapter (120) is provided with magnetic fastening means (123) and with means for contactless transfer of electrical power in that the plug adapter (120) comprises a secondary side (133) of a transformer (132) for transferring power from the plug adapter (120) to a receptacle adapter (110) without physical contact between power transferring parts, characterized in that
the plug adapter (120) comprises a main body (121) accommodating the secondary side (133) of the transformer (132) and the magnetic fastening means (123), the magnetic fastening means (123) protruding from the main body (121) and adapted for arrangement to magnet fastening means (113) of the receptacle adapter (110).
